(19) United States
(12) Patent Application Publication
(10) Pub. No.: US 2010/0319027 A1
(43) Pub. Date: Dec. 16, 2010

(54) SEARCH ADVERTISEMENT BIDIRECTIONAL DATA BROADCASTING SYSTEM AND GENERATION METHOD THEREOF

(76) Inventor: In-Jung Kim, Keongbuk (KR)

Correspondence Address: HARNESS, DICKEY & PIERCE, P.L.C., P.O. BOX 8910, RESTON, VA, 20195, US

(21) Appl. No.: 12/449,374

(22) PCT Filed: Feb. 4, 2008
(86) PCT No.: PCT/KR2008/000682

§ 371 Date: Aug. 5, 2009

(30) Foreign Application Priority Data
Feb. 21, 2007 (KR) 10-2007-001462

(51) Int. Cl. H04N 5/445

(52) U.S. Cl. 725/42; 725/53

(57) ABSTRACT

The following invention is about a system for searching information and using interconnected advertisement service by TV Search System and Advertisement Managing System. The system following a desirable application of the invention includes a TV search application that enters a search word that works on a interactive data broadcasting TV that the viewer wishes to search, sends the word to the TV search system through an interaction channel, receives the search result and help the viewer navigate; a TV search return system that sends back through the interaction channel the search result of the search word and that the TV search application requested and some related advertisement content; an advertisement managing system that manages the advertisement connected to the search word; a client application that help the advertiser to operate the functions of the advertisement in a distant place. Through the use of this invention provide convenient search service on TV and make earning models by linking advertisements.

### TECHNICAL FIELD

The fields of technique of the following invention are Data broadcasting, TV search service and search advertisement.

### BACKGROUND ART

Through the development of DTV, there are fundamental possibilities to realize the search service by using the advantages of the interactive data broadcasting system. But there are some problems that need to be solved for the actual service.

Also, the Internet search engine has gone through a lot of development hitherto. But the technology was only relevant in searches related to PC environment, not suitable for TVs.
It is not only difficult to access to the appropriate site on a TV with a Digital TV interactive Data broadcasting middleware, but it is also impossible to use the service although the appropriate site is made to fit in PC internet browser and therefore accessed by the Data broadcasting system.

The expression by the Data broadcasting standard is also different from that of the Internet.

As a reference, JAVA VM that enables the execution of JAVA Xlet is basically installed in the domestic Data broadcasting DTV receiver, but in usual cases the browser is not installed. In addition, unlike PCs, TVs do not use a pointing device, but works with a remote control. So it is difficult to use the search service that is produced with a pointing device. It is also difficult to use the full screen to show the information found because of the display on TV. The display must be kept on TV while the information is passed to the viewer.

Compared with PCs, TVs have lower memory, CPU power, H/W . . . etc and by S/W TVs also have poor environment for browser, flash, ActiveX . . . etc. This is why it is necessary to construct a search engine that fits the features and efficiency of TVs.

### DISCLOSURE OF INVENTION

### Technical Problem

Although there are some questions aroused while watching the TV, there is no way to get the answer in the current TV system. Especially during quiz shows or entertainment programs where questions need to be solved, the viewer instantly hopes to search it on the Internet if there is a PC nearby. But the viewer also thinks that moving to a PC and booting it to search the information and coming back again to the TV with parts of the show missed is an inconvenient process. The viewer may be interested at a shooting scene during movies and dramas or wish to visit the restaurants displayed in culinary shows. But it is impossible to get any precise information through the show. The following invention takes care of such inconvenience by enabling the direct search of any information while watching TV and introduces a new business model by integrating a linked advertisement.

The purpose of this invention is a Search Application that enables a viewer to enter a search and navigate the result on a Data broadcasting middleware TV, a TV search return system that makes it possible to display the search result by the search application and produce contents possible to navigate on TV, and an advertisement DB, advertisement client application, advertisement managing system that control the advertisement relevant to the search and manage the viewers advertisement references.

### Technical Solution

The structure of the invention consists of a search application (100) that is to be executed on TV, an interconnected TV search return system (200), and advertisement managing system (300) such as advertisement DB (500), advertisement client application (800).

Search application (100) works in a TV with data broadcasting middleware, provides GUI that enters the information that the viewer wants to search, requests search results to the TV search return system for the search word (900) that the viewer entered through Interaction channel, receive the search result contents (400) sent by the TV search return system (200) and display it to the viewer, and enable the viewer to watch while navigating the search result contents (400). Search application (100) can be built in the TV receiver. TV search return system (200) brings the lookup result from search DB on the search word that the viewer requested in the search application (100), inquire the advertisements relevant to the search word in the advertisement DB (500) and organize the contents so that it would fit the TV layout, and make a search result contents (400) format that the search application (100) is capable of decoding to send to search application (100) through interaction channel.

The search DB referred by the TV search return system (200) can be a search DB (700) that is directly expressed, and it also can gain information by integrating the DB or the API that the Internet or the existing search engine (600) provides. For advertisement DB (500) it is possible to directly refer to the advertisement DB (500), or gain the advertisement content by corresponding to the advertisement managing system (300). Undoubtedly, advertisement DB (500) and advertisement managing system can be built in the TV search return system as modules to form one system or be separated to form separate systems. Also, Search result contents (400) can only include advertisement contents or include all the detailed information of the advertisement to send to the Search application (100) at once. The method of sending only the content first has the effect of minimizing the capacity of the Search result content (400) because there may be some information that the viewer wouldn't use among the detailed advertisement. The information formed by the TV search return system (200) is transferred to the search application (100) and displayed on the TV screen. Search application (100) provides the UI so that the viewer can view the search result and the advertisement content while navigating, and request the detailed information of one of the advertisement in the content that the viewer chooses to the TV search return system (200), using the Interaction channel. TV search return system (200) inquires of the advertisement contents in the application DB and sends it to Search application (100), and make the viewer save the viewed record in the Advertisement DB (500) or send to Advertisement managing system (300) so that it can save the record in the advertisement DB (500). It is possible to let the Search application (100) directly access to advertisement managing system (300) without using the TV Search Return system (200) depending on how the system is structured. It is also possible to use again, as a search word in the TV Search Return system, a specific word in the information sent as a search result. In this case, the search service can be used in the same way as the first search scenario.

The function of Advertisement DB and Advertisement Managing System (300) is to save and control the advertisements related to the Search Word (900).

Advertisement DB (500) saves the information related to the Search Word (900) and contains the Advertisement Content that is shown when a specific advertisement is chosen. In addition, Advertisement DB (500) records the viewer's reference report by advertisement.

The Advertisement Managing System (300) reflects the advertisement fee paid when the chosen advertisement is exposed and the operation of conditions such as choosing the advertisement related search word, advertisement start/stop . . . etc. on the applied Advertisement DB (500). Ultimately, the advertisement content related to the Search Word (900) can be decided on different conditions. The easiest thing is that it is possible to allocate by the order of the advertisement registration or the opposite, and also in the order of the advertisement charges that the advertiser decides. In addition, it is possible to apply channel information, regional channel allotment information, and the network/regional commercial broadcast/broadcasting regional bureau/PP's organization ID in the broadcasting TS to analogize regional circulation information and choose the advertisement appropriate for each region.

The TV Search Return System (200) and the Advertisement Managing System (300) consider the viewers accessing simultaneously, so they apply the load balancing technique through L4 Switch . . . etc. Also, it is possible to use a duplex architecture for the stability.

Various kinds of DB can also apply techniques such as Clustering to consider the stability of the viewers accessing simultaneously.

Advertisement Managing System (300) provides a plan for the advertiser or the advertising agency (mentioned as advertiser later on) to operate their advertisement at a remote location. They can use a separate advertiser Client Application (800) or a general Web Browser (800) to operate in a remote location through the Internet. Undoubtedly, it is possible to apply security techniques to manage the safety.

The Advertisement Managing System (300) produces the calculated advertisement fee report by obtaining the viewer's utilization statistics per advertisement. During this time, the malicious access attempts that are meant to harm the advertisers are filtered.

The Advertisement Managing System (300) includes functions such as forced shutting that can restraint when there are technical problems or problems with the advertisement content.

The calculated advertisement fee is paid online or offline.

FIG. 1 is a system module composition following the invention's desirable operation.

Referring to FIG. 1, the following invention consists of Search Application (100), TV Search Return System (200), Advertisement Managing System (300), Search Result Contents (400), Advertisement DB (500), Advertiser Client Application (800). The Search result retrieved by referring to the search DB (700) or by linking the keyword that the viewer entered in the Search Application (100) with an outside Search Engine (600) in the TV return system and the related advertisement list in the advertisement DB (500) are made into the form of search result contents (400) and then sent to search application. The Search Application (100) is used to display the Search Result Contents on TV, provide the UI that the viewer can navigate, accumulate the advertisement viewed record in the Advertisement DB (500) when a viewer chooses a specific advertisement by sending the information to the TV Search Return System (200) or the Advertisement Managing System (300), and display on TV the detailed advertisement contents returned. The Advertisement viewed record, excluding the abnormal record, is used to keep an accurate account of the advertisement fee.

FIG. 2 is a system module block chart following the invention's desirable operation. The content of FIG. 2 is the system composition of when the explanation of chart 1 is implemented

FIG. 3 is a service scenario following the invention's desirable operation.

The viewers following FIG. 3 start the Search Application and enter the search word (a) to search the missing information while watching TV. The Search Application requests the search to the TV Search Return System, receives the Search Result and displays it on the screen (b). The detailed contents are displayed on the screen if one among the advertisement content in the Search Result is chosen (c).

FIG. 4 is a flow chart following the invention's desirable operation.

By referring to FIG. 4, the search word is entered. (s10)

Request for the record of the registered search word to the TV Search Return System (200). (s20)

Receive the Search Result Contents (400) that the TV Search Return System (200) sends after referring to the Search Word (900). (s30)

Check whether the reference result is successful. (s40)

If the reference result fails, indicate reference fail. (s50)

If the reference result succeeds, interpret the Contents (400). (s60)

Display the interpreted Contents. (s70)

Receive the input of the viewer's remote control and make the Contents possible to navigate. (s80)

Check whether the item the viewer chose is one of the advertisement content. (s110)

If one of the advertisement content is chosen, transmit the chosen advertisement information. (s90)

Receive the advertisement contents. (s100) Because the process is same after sending the advertisement contents and the search result contents, move to the reference result examination stage. (s40)

During the navigation, if one of the advertisement content is not chosen, check whether the viewer will request for a search again. (s120)

If the search is requested again, move to the entering search word stage, and if not, exit.

The following explanation is only a foreshadowed explanation of the invention's technical aspect. Therefore, any person with a common knowledge on the technical field of the invention would be able to make changes and adjustments without deviating from the invention's original intent.

Hence, the application examples of the invention are not to restrict its technical field but to explain; the boundary of the invention's technical aspect is not restricted because of these examples. The invention's protection boundary must be translated according to the requested extent below, and all the technical aspects within the extent should be interpreted as included in the invention's rights boundary.

### ADVANTAGEOUS EFFECTS

The convenience of this invention is that it is possible to search from the TV the curious questions that arouses while watching TV. In the position of the network, they can improve their image by providing useful service. By displaying the advertisements related to the search word, the viewer can gain access to informative advertisement that they need, not useless spam advertisements. The advertisers can also get a way to gain access to the TV advertisement in a cheaper way, unlike the expensive TV projection advertisement. In addition, the network can raise their existing advertisement earnings by using additional advertisement earnings.

### BRIEF DESCRIPTION OF THE DRAWINGS

FIG. 1: the system module block chart following the desirable operation of the invention

FIG. 2: the system composition following the desirable operation of the invention

FIG. 3: the service scenario following the desirable operation of the invention

FIG. 4: the flow chart following the desirable operation of the invention

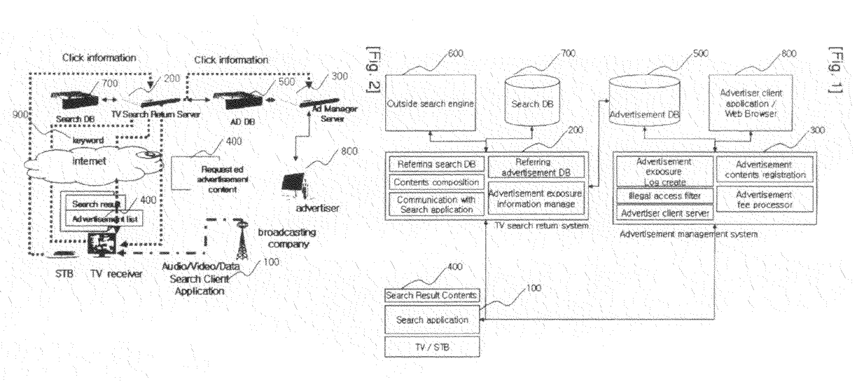

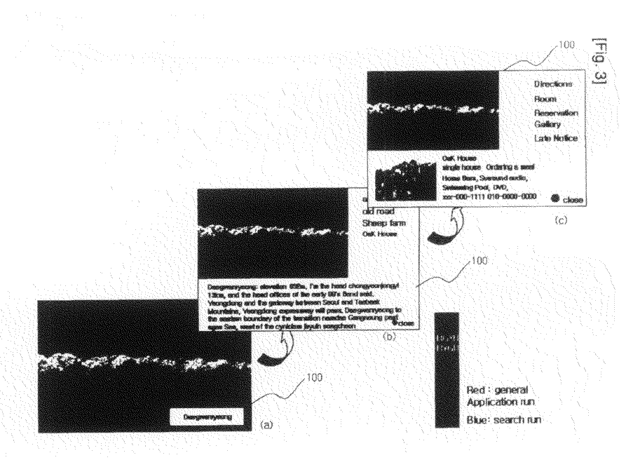

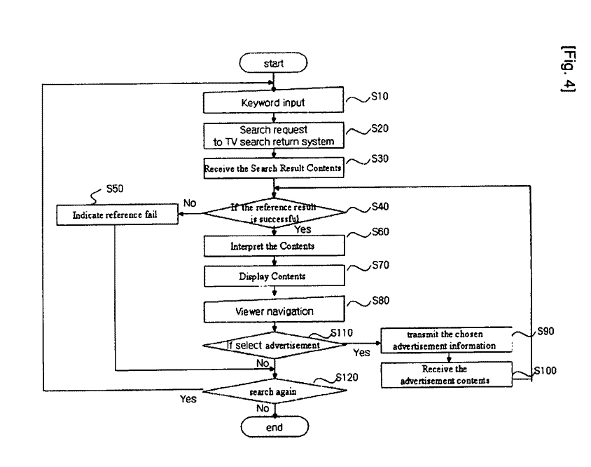

### EXPLANATION OF THE SIGNS ABOUT THE MAIN PART IN THE PLAN

100: Search Application
200: TV Search Return System
300: Advertisement Managing System
400: Search Result Contents
500: Advertisement DB
600: Outside Search Engine
700: Search DB
800: Advertiser Client Application
900: Search Word

### BEST MODE FOR CARRYING OUT THE INVENTION

The best form for the invention's operation is to consist Search Application (100), TV Search Return System (200), Advertisement Managing System (300), Search Result Contents (400), Advertisement DB (500), and Advertiser Client Application (800) executed on TV to make the viewer enter search words on TV, refer to the result of the search, see the advertisement related to the search word, and realize a TV search advertisement service

### MODE FOR THE INVENTION

The best form for the operation of the invention is to consist Search Application (100), TV Search Return System (200), Search Result Contents (400) executed on TV, to make viewers enter a search word, provide a way to refer to the search result, and other services such as advertisement related to the search, commercial transactions . . . etc.

### INDUSTRIAL APPLICABILITY

The following invention can be used on terrestrial digital TV, digital cable TV, digital satellite TV, IP-TV, DMB . . . etc. and in diverse areas where search is connected with advertisement such as compound broadcasting or regional broadcasting.

### Sequence Listing

Interactive TV, Data Broadcasting, Search Advertisement

1. A search application in TV search service system providing keyword entering UI to the viewer, searching the keyword in the TV search return system through the interaction channel, displaying the search result content received from the TV search return system, including the UI so that the viewer can navigate through the search result content; a search result content made in adequate form to inquire of the search result of the prior service on TV; a TV return system that searches the received keyword, organize into search result contents and send the search result through interaction channel.

2. The search application in claim 1 can be built-in a TV receiver, distributed in the form that works after emitted and sent to TV or STB, or it can be merged and initially emitted to be built-in the receiver. In case of continuous use, the search application in the receiver is used and in case of upgrade, distribution through emission is used.

3. The TV search return system in claim 1 includes the function that collects the search result by searching in the search DB or asking the preexisting search service.

4. The search application in claim 1 can replace the browser if there is a built-in browser in the TV receiver.

5. A system that enables advertisement service by applying a search system on TV that includes; a search application in TV search service system providing keyword entering UI to the viewer, searching the keyword in the TV search return system through the interaction channel, displaying the search result content received from the TV search return system, including the UI so that the viewer can navigate through the search result content; a search result content made in adequate form to inquire of the search result of the prior service on TV;
a TV return system that searches the received keyword, organize into search result contents and send the search result through interaction channel;
An Advertisement DB that stores the advertisement contents, advertisement fee, advertiser information, and search information;
An advertisement managing system that manages advertisement subjects and contents related to the advertisement;
An advertiser client application that enables the advertiser to control the operation of the contents related to the advertisement in a distant place.

6. The search application in claim 5 can be built-in a TV receiver, distributed in the form that works after emitted and sent to TV or STB, or it can be merged and initially emitted to be built-in the receiver. In case of continuous use, the search application in the receiver is used and in case of upgrade, distribution through emission is used.

7. The TV search return system in claim 5 includes the function that collects the search result by searching in the search DB or asking the preexisting search service.

8. The search application in claim 5 can replace the browser if there is a built-in browser in the TV receiver.

9. The search application in claim 5 includes the functions that send the advertisement selected by the viewer that was sent to the contents as a search result, to TV search return system or the advertisement managing system and provide a GUI so that the viewer can watch it by receiving the selected advertisement's precise content.

10. The TV search return system in claim 5 includes functions that receive information on the viewer's advertisement choice from the search application to send to the advertisement managing system or directly record the information in the advertisement managing system's DB and send the detailed information of the selected advertisement in contents to the search application.

11. The advertisement managing system in claim 9 includes functions that receive the viewer's advertisement search information from the search application to record in the advertisement managing system's DB, and directly send the selected advertisement's detailed information in contents to application if the information is directly comes from the search application.

12. Includes a method that when the advertisement content used in the search result content in claim 5 exceeds the number expressed on TV, it is arrayed by the advertisement fee that the advertiser selected and the prior allotted advertisement is chosen by the number expressed on TV to be included in the content.

13. Includes a method that when the advertisement content used in the search result content in claim 5 exceeds the number expressed on TV, it is arrayed by the order that the advertiser registered or by the reverse order and the prior allotted advertisement is chosen by the number expressed on TV to be included in the content.

14. Include a method that if the advertisement content used in the search result content in claim 5 is set, the regional channel allotment, current channel information, organization in the broadcasting TS are used to infer the viewer's regional information to include in the content the advertisement that belongs to that field.

15. The advertisement managing system in claim 5 includes a server function that enables the advertiser in a distant place to stop/restart the advertisement related keyword, control the advertisement fee and the advertisement projection region through the client application or the internet using web browser.

16. The advertisement managing system in claim 5 includes functions that enables the advertiser to stop/restart the advertisement projection and registers advertisement contents.

17. The advertisement managing system in claim 5 includes functions that aggregate the advertisement inquiry history and filter unusual advertisement search.

18. The method of paying online or offline the advertisement fee of the aggregated advertisement inquiry history in claim 17

19. The search application in claim 5 includes advertisement that displays default word when the viewer enters a keyword in the search window. This word can be replaced by linking to a video program or a specific period.
